(19) United States
(12) Patent Application Publication
(10) Pub. No.: US 2002/0014200 A1
(43) Pub. Date: Feb. 7, 2002

(54) Granule coating apparatus and method

(76) Inventors: Terry L. Stemler, Sunfield, MI (US); David Mattice, Woodland, MI (US); Kendall L. Wilcox, Sunfield, MI (US)

Correspondence Address: MILLER JOHNSON SNELL COMMISKEY, 800 CALDER PLAZA BUILDING, 250 MONROE AVE N W, GRAND RAPIDS, MI, 495032250

(21) Appl. No.: 09/840,596

(22) Filed: Apr. 23, 2001

Related U.S. Application Data
(60) Provisional application No. 60/199,452, filed on Apr. 25, 2000.

(51) Int. Cl. B05C 11/02; B05C 13/00; B05C 13/02; B05D 3/12; B05D 7/00; B05D 1/02

(52) U.S. Cl. 118/52; 427/212; 427/240; 427/421; 118/300

(57) ABSTRACT

A coating machine having an improved liquid atomizing array for applying a liquid coating on the granules, comprising a housing having a flow collar at one end for controlling an influx of the granule material. A rotatable granule-distributing disc is disposed below the flow collar for producing a cylindrical curtain of granule material falling through the housing. A scraper assembly is attached below the granule-distributing disk to rotatably engage an inner surface of the housing. An array of liquid atomizing discs is disposed along the longitudinal axis of the housing and below the rotatable granule-distributing disc. Each of the discs is generally circular in plan form and having a serrated peripheral edge defining a lineal circumference greater than that of a circle having a diameter equal to that of the disc. A drive system below the housing is interconnected to the plurality of liquid atomizing discs to rotate the discs at a speed in excess of two thousand revolutions per minute. A liquid dispenser coaxial with said rotatable granule-distributing disc dispenses the liquid coating onto the spinning discs. A discharge chute is provided at the bottom of the housing for gathering the liquid-coated granule material for transport to another location.

### BACKGROUND OF THE INVENTION

1. Field of the Invention

The instant invention relates generally to a method and apparatus for applying a coating to a material, and more particularly, to a method and apparatus for applying a liquid coating to granular matter.

2. Description of the Related Art

Granular coating machines are typically used to coat fatty substances on feed pellets for animals. Historically, equipment used to mix a fatty substance with the feed lacked the capacity to coat each of the individual pellets uniformly and continuous at a high output rate. Consequently, in order to provide a large output on an economical basis, feed manufacturers often mixed the fatty substance into a heterogeneous composition rather than a homogeneous one. One of the earlier proposed solutions provided a housing into which dry materials were introduced from the top and removed from the lower end. Extending vertically down through the central portion of the housing was a shaft mounted on bearings which was coupled by a belt to an electric motor. The shaft had an internal passageway through which heated fatty substances in the form of a liquid stream were fed from a control orifice. Positioned beneath the lower end of the hollow shaft was a solitary dish and which received the flowing stream in its center. The dish was mounted by a hub to a shaft of an electric motor which was mounted within the housing. Affixed to the lower end of the shaft for the heated fatty substance was a granular-distributing disk and coaxial with the liquid-distributing disk.

In operation, the liquid fatty substance was sent through the hollow shaft and down onto the center of the dish. The dish was rotated to cause the liquid to be centrifugally thrown from the periphery of the dish. Simultaneously, dry material in the form of pellets was feed onto the surface of the distributing disk. The distributing disk was rotated at approximately 70 revolutions per minute to provide a controlled, variable flow rate for the dry material. The individual particles were thrown from the distributing disk against the inner wall of the housing were they were guided through a mono-layer of liquid particles thrown off from the liquid-distributing dish. The partially coated particles passed were collected in the bottom of the housing where a conventional ribbon mixing screw mechanism was used to move the coated material from the bottom of the housing to another location. During the transport, the dry material was stirred, wherein liquid on certain granules was transferred to other granules. Throughout the 60's, 70's, and 80's, other apparatus were devised wherein liquid particles were spun from a single spinning disk. For example, the reader is referred to U.S. Pat. Nos. 3,359,942 to Price; 3,912,231 to Weber; 4,275,682 to Weber; 4,318,941 to Gillett et al; 4,320,715 to Maloney et al; 4,398,493 to Gillett et al; 4,407,217 to Jackson; 4,657,773 to Muller; and 5,891,246 to Lund.

A substantial disadvantage associated with each and every one of the prior devices is the flow rate of the granular material through the housing was very often excessive wherein only those particles closest to the liquid-distributing dish received any coating as they fell to the bottom of the housing. Moreover, the width of the liquid plane through which the granular material passed was often too narrow to provide sufficient surface area exposure of the granule. What more often occurred was that some liquid coating was transferred to the other granules at the bottom of the housing where the granules collected and were moved by a conveyor mechanism to another location. Often, by this time, the coating material was congealing or setting and complete coverage of the granular material was inhibited.

It is an object of the instant invention to substantially improve the exterior coating of the granular material during its descent through the housing to maximize coverage and greatly improve the overall end product.

### SUMMARY OF THE INVENTION

According to one embodiment of the invention, a coating apparatus for granules is provided, comprising a housing and a rotational, granule-distributing disk disposed within the housing proximate an upper end. Also located withing the housing and below the rotational, granule-distributing disk is an array of liquid atomizing disks, each of which has a set of openings arranged concentrically thereon. Positioned below the rotational, granule-distributing disk, and immediately above the array of atomizing disks is a liquid dispenser. In a preferred embodiment, the liquid dispenser is coaxial with the rotational granule-distributing disk.

According to another form of the invention, the granule liquid coating machine includes a housing having an inlet located at one end. A lower end of the inlet is positioned above the granule-distributing disk. The amount of granule material introduced to the granule-distributing disk is controlled by a collar attached to the lower end of the inlet. Below the granule-distributing disk is an array of liquid atomizing disks, the array including a plurality of vertically-stacked, serrated circular disks, each spaced from the other and having concentrically arranged openings to permit fluid flow to the lower disks. The liquid is introduced to the array of atomizing disks through a conduit coaxial with a shaft driving the granule-distributing disk.

In yet another form of the invention, a housing having an inlet is provided for introducing dry granule product onto an axially disposed granule-distributing disk. The flow of granule material from the inlet onto the distributing disk is controlled by an adjustable, flow-control collar attached to the lower end of the inlet. A shaft extending downwardly into the housing rotates to the distributing disk, and also provides the conduit for the introduction of the liquid through the bottom of the shaft. The distributing disk is also attached to a scraper assembly. The scraper assembly includes at least one radial arm terminating in a vertical member proximate the inner wall of the housing to remove excessive buildup of granule material along the interior wall. Below the shaft for the granule-distributing disk and scraper assembly is the liquid atomizing array including a plurality of disks arranged vertically in tandem, separated from one another by coaxial conical spacers. All but the lowermost atomizing disk contain concentrically arranged opening to permit liquid access to all disks in the array. The atomizing disks are rotated at speeds in excess of seventeen hundred revolutions per minute to create a zone of atomized liquid which contacts the descending curtain of granules. The array of liquid atomizing disks create air currents within the housing which move the atomized liquid into contact with the granules.

In still another form of the invention, a liquid atomizing array for a granule coating machine is provided, having a plurality of disks stacked vertically in tandem relative to one another. Each of the disks forming the array includes a concave upper surface, is generally circular in plan form, and includes a serrated peripheral edge defining a lineal circumference greater than that of a circle of equal diameter. Each of the disks further includes one or more perforations or holes arranged thereon to permit liquid to pass from an upper disk to a lower disk.

The instant invention also provides a unique method for coating granule material using the coating apparatus of this invention. The improved method includes the steps of dispensing granule material into an inlet hopper of the machine and controlling a flow of the granule material from the inlet hopper onto a rotating granule-distributing disk disposed within the housing. The flow of the granule material onto the rotating disk causes the granule material to fall within the housing in a cylindrical curtain of granules. The method further includes spinning an array of stacked liquid dispensing disks about an axis coincident with that of the granule-distributing disks at speeds in excess of two thousand revolutions per minute. While the disks are spinning, a liquid to coat the granules is dispersed onto the array of stacked liquid atomizing disks through a shaft coaxial with the granule-distributing disk, and causing the liquid to be atomized and dispersed radially from the array of stacked disks to create a zone of atomized liquid through which the falling cylindrical curtain of granule material passes. The spinning action of the array of stacked liquid atomizing disks further creates air currents within the housing to encourage the collision of the atomized liquid with, and coat, the granule material. Once the granules are coated, they are collected at the bottom of the housing along with any excess liquid and further mixed together during transport to a desired location.

The advantages presented by the instant inventions and its different forms include better coating efficiency, more efficient consumption of raw materials, resulting in a better product. The length of the array of atomizing disks, together with the increased rotational speed and peripheral surface area of the disks, creates a larger zone of coating liquid. Furthermore, coating efficacy is greatly increased as a result of the finer mist and enhanced action of the mist produced by the air movement within the housing. As a result, more surface area of each of the granules is coated with the desired liquid, improving product quality. Moreover, because the raw materials are used more efficiently, less is required, producing a cost saving, which in turn, should equate to less expensive final product. Another major advantage is the range of uses of the invention—machine versatility. The instant invention is suitable for coating food products with vitamin supplement coatings, flavor enhancing compounds, or preservatives. Alternatively, the invention could be used in the composite lumber industry where saw dust and board chips are coated with adhesive. These and further advantages of the instant invention with become apparent to reader when reading the detailed description in association with the appended drawing figures.

### BRIEF DESCRIPTION OF THE DRAWINGS FIGURES

FIG. 1 is a front elevation view of a granule coating machine embodying the instant invention;

FIG. 2 is a side elevation view of the invention shown in FIG. 1;

FIG. 3 is a plan view of the invention shown in FIG. 1;

FIG. 4 is a front section view of the invention shown in FIG. 3 and taken along lines IV-IV;

FIG. 5 is a side section view of the invention shown in FIG. 3 and taken along lines V-V;

FIG. 6 is a fragmentary section view of the invention shown in FIG. 4;

FIG. 7 is a fragmentary section view of the invention shown in FIG. 4 and taken along line VII-VII;

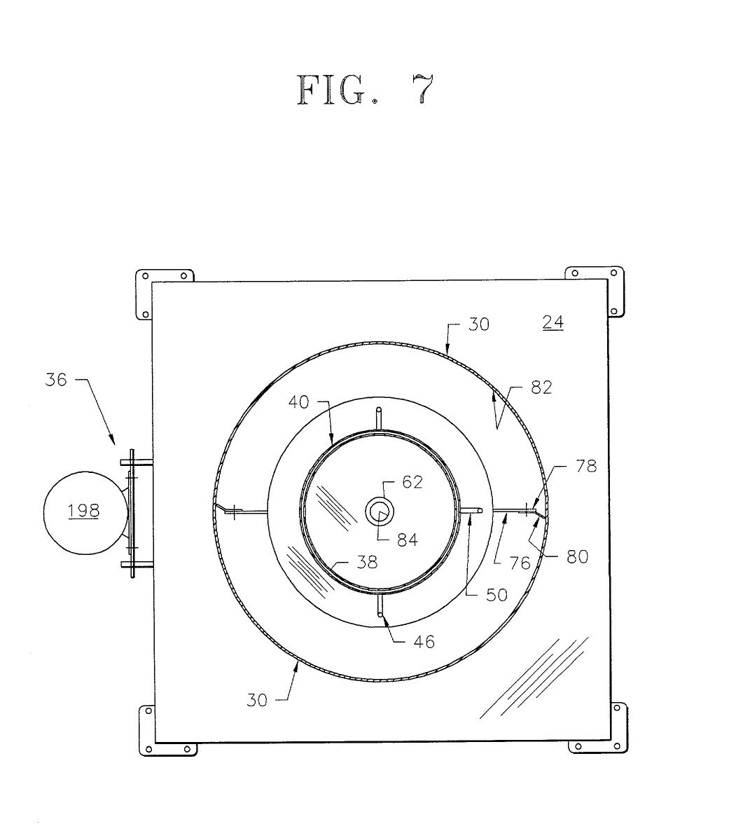

FIG. 8 is a fragmentary elevation section view of the granule-distributing disk and scraper assembly;

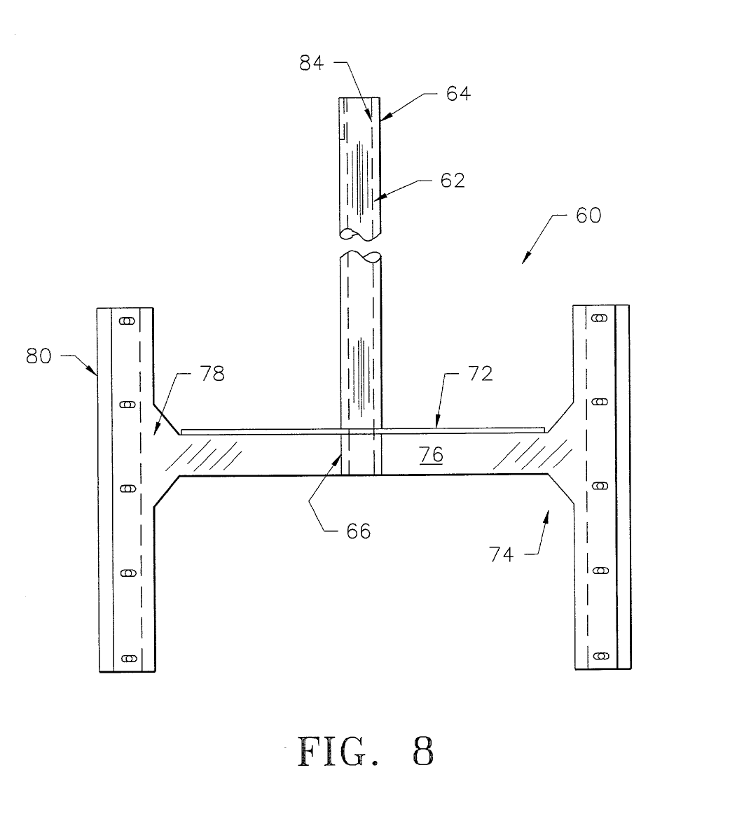

FIG. 9 is a fragmentary plan view of the scraper assembly;

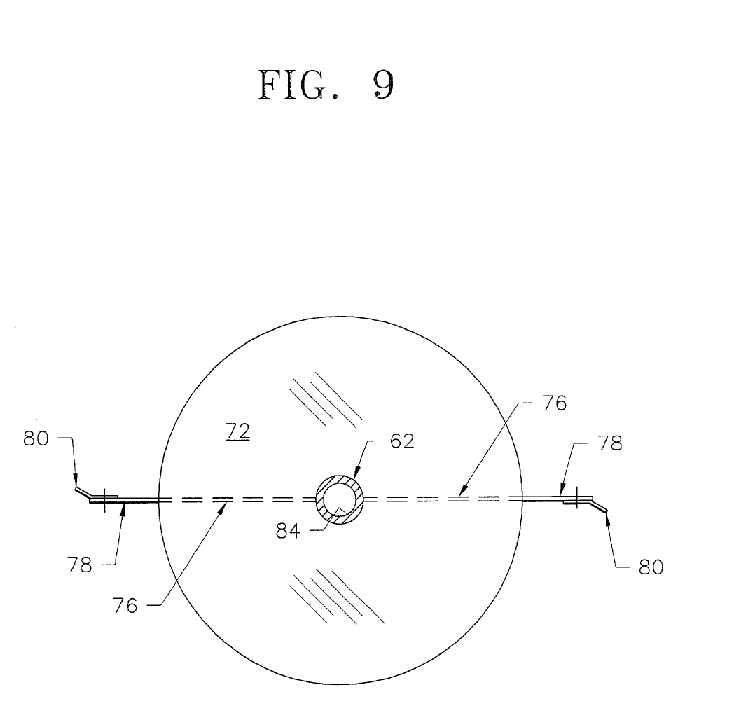

FIG. 10 is a fragmentary elevation view of the liquid atomizing array;

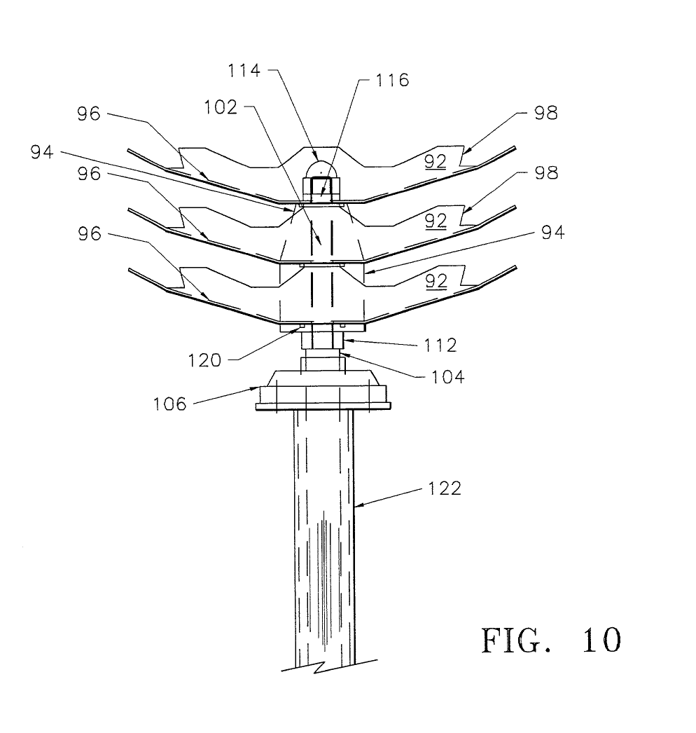

FIG. 11 is an exploded elevation of the liquid atomizing array;

FIG. 12 is a plan view of the three atomizing disks of the array; and

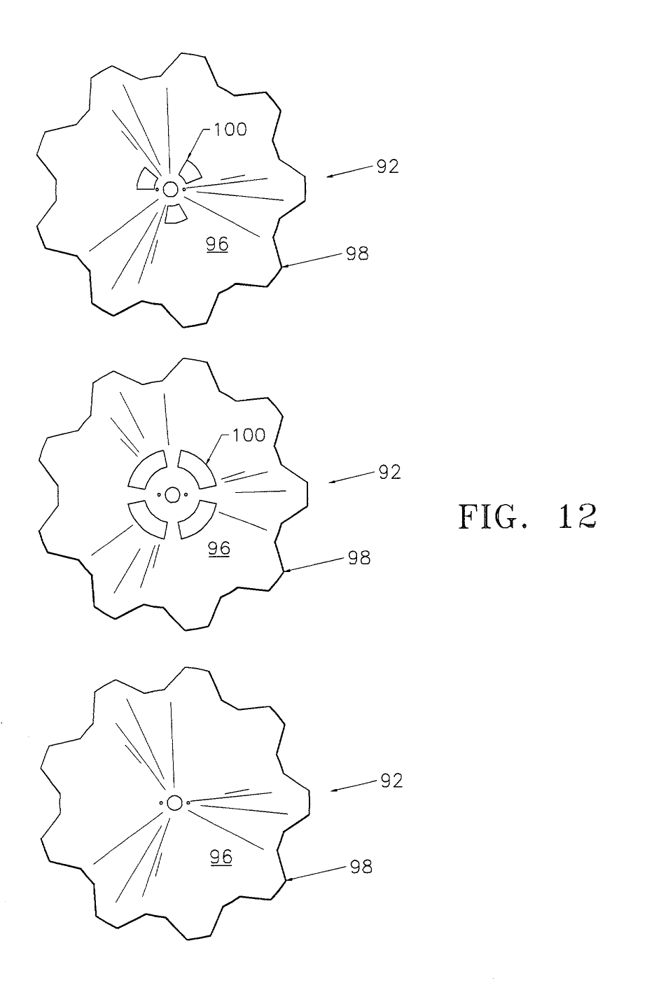

FIG. 13 is a schematic diagram illustrating one system employing the instant invention.

### DETAILED DESCRIPTION OF THE VARIOUS EMBODIMENTS

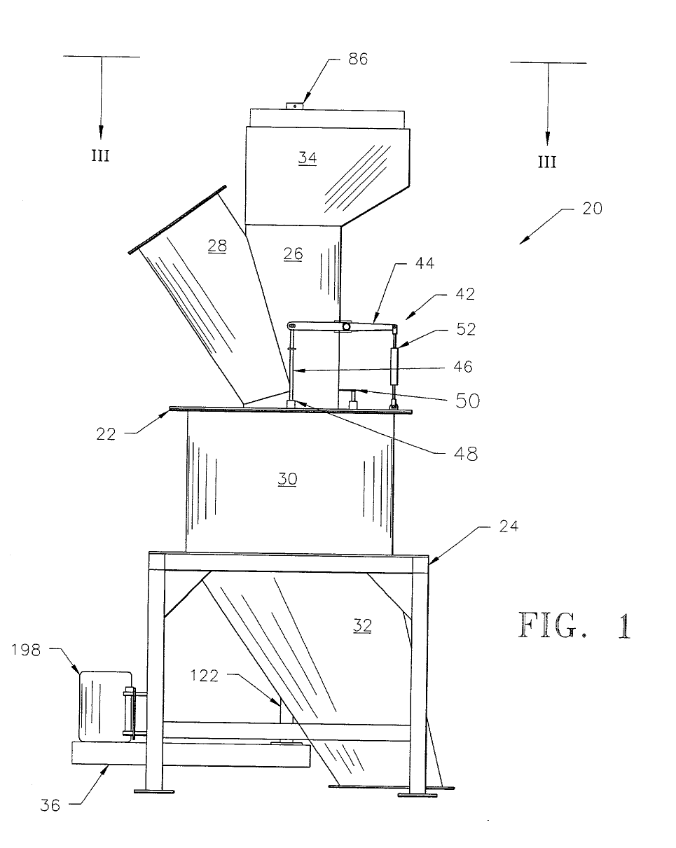

For purposes of the following description, the terms “upper,” “lower,” “left,” “rear,” “front,” “vertical,” “horizontal” and derivatives of such terms shall relate to the invention as oriented in drawing FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Specific dimensions and other physical characteristics relating to the embodiments disclosed herein are not to be considered as limiting, unless the claims expressly state otherwise.

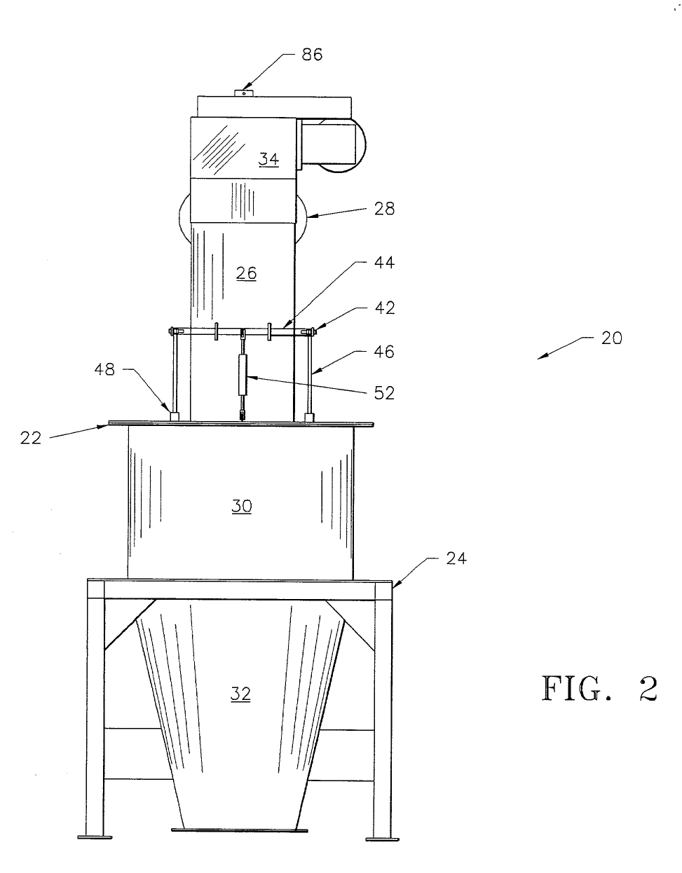

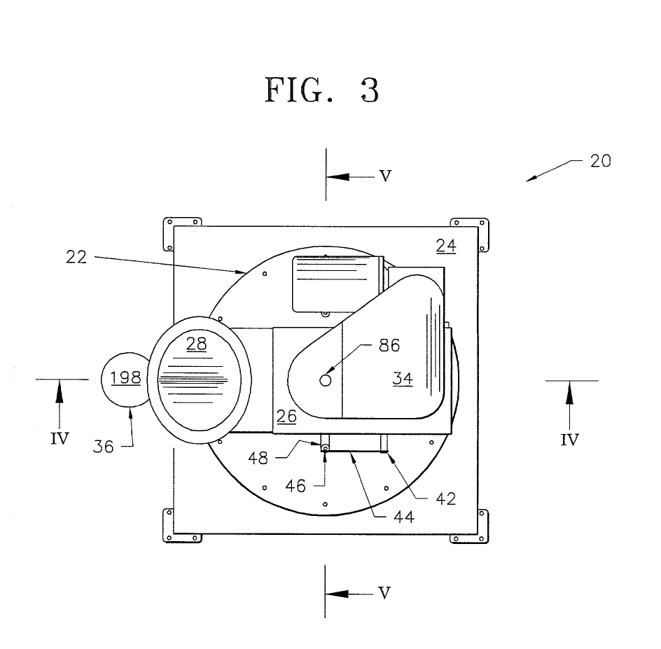

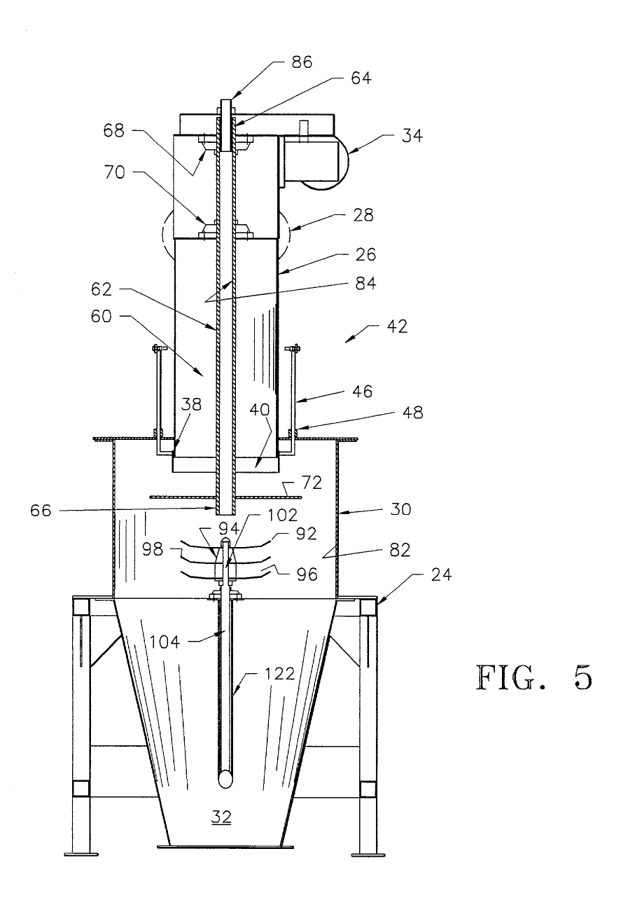

Referring to FIGS. 1 through 5, one embodiment of the coating machine 20 is illustrated which includes a housing assembly generally identified by reference number 22 supported in a preferred orientation by a frame assembly 24. The housing assembly 22 contains the coating apparatus into which granules or other materials are coated with a liquid mixture. The housing assembly 22 includes an upper housing assembly 26 which is coupled to and receives an angularly disposed inlet hopper 28. Both the upper housing assembly 26 and the inlet hopper 28 are attached to the upper end of a coating chamber 30 which is illustrated in the figures as being located above the frame assembly 24. Extending from the lower end of the coating chamber 30 is a discharge transition 32 which is configured to discharge the product to another apparatus described below. Each of the different components of the housing assembly 22 are preferably made from 10 gauge carbon steel, but also may be formed from stainless steel sheet as well depending upon the desired application. Also described in greater detail below are the two drive assemblies illustrated here as reference number 34 at the upper end of upper housing assembly 26, and the lower drive assembly 36 positioned below the coating chamber 30 and adjacent discharge transition 32.

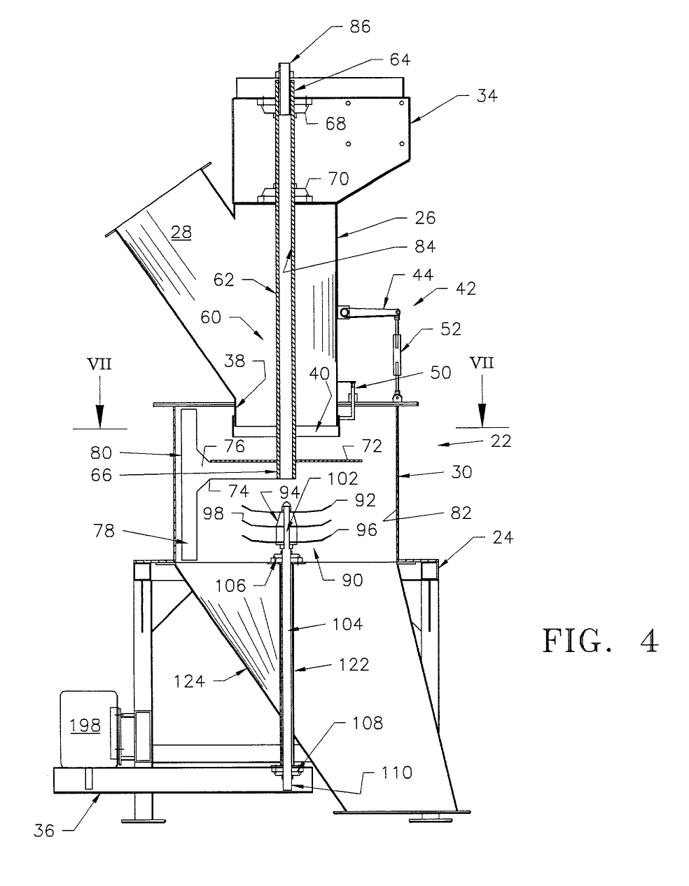

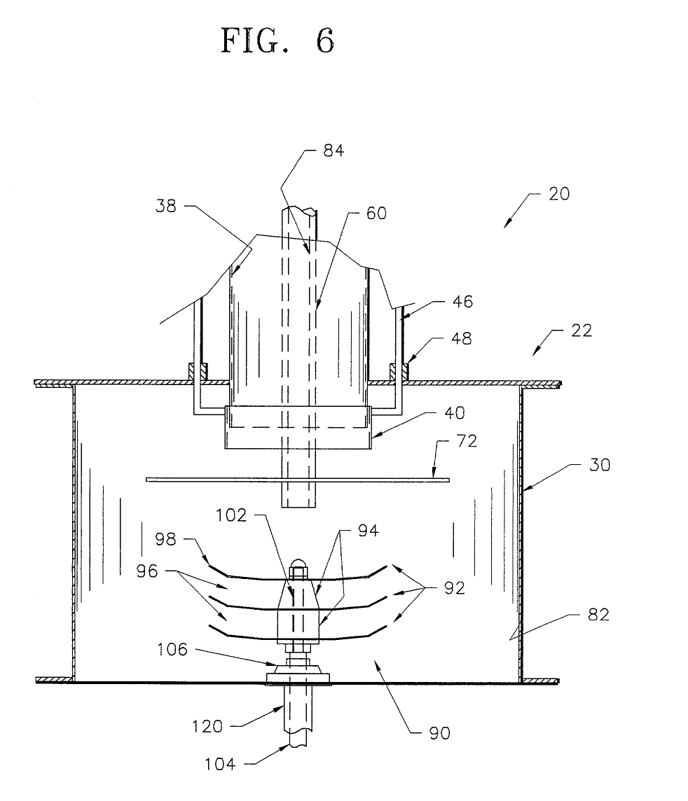

The interior of the coating machine 20 and the respective components are best illustrated in FIGS. 4 through 6. As briefly mentioned above, the upper housing assembly 26 and inlet hopper 28 receive the granular material for the coating machine. The flow of the granules through the coating machine 20 is controlled in large part by a flow control collar 40 concentrically disposed about and generally surrounding the lower end of the inlet 38. The flow control collar 40 includes a generally cylindrical sleeve formed from the same type of material used to manufacture the housing assembly 22. The flow control collar 40 is mounted in telescopic relation to the lower end of the inlet 38, controlled by an adjustment mechanism generally referenced as 42. The adjustment mechanism 42 includes a spur-shaped lever 44 which is coupled at the base of the spur to the upper housing assembly 26 by a hinge and coupled at one end to vertically extending linkage arms 46. Each of the linkage arms 46 pass through passages 48 formed at the top of the coating chamber 30 and are connected at their lower ends to the flow control collar 40. Movement of the spur-shaped lever 44 causes the linkage arms 46 to move the flow control collar 40 up or down relative to the lower end of the upper housing assembly 26. The relative height of the flow control collar 40 is indicated by a height limiter/gauge assembly 50 on the front side of the upper housing assembly 26. The height limiter/gauge assembly 50 may take on any one of a number of forms, but for the sake of simplicity is illustrated in FIG. 4 as a pin attached to the flow control collar 40 which extends up through the upper end of the coating chamber 30. The end of the pin is measured relative to a reference line or point on the upper housing assembly 26. The position of the flow control collar 40 is maintained at the desired height by a turn buckle assembly 52 which is anchored at one end to the upper end of the coating chamber 30 and at the opposite end to an end of the spur-shaped lever 44. Alternatively, a screw linear actuator (not shown) may be substituted for the turn buckle 52 to provide remote adjustments.

Disposed within the coating chamber 30, and extending coaxially through the upper housing assembly 26 up into the upper drive assembly 34 is a granule distributing assembly 60. The granule distributing assembly 60 includes a hollow tubular shaft 62 having a first end 64 extending upwardly through the upper drive assembly 34. A second and opposite end 66 extends into and terminates in the coating chamber 30 such that the axis of the tubular shaft 62 is substantially coaxial to the longitudinal axis of the upper housing assembly 26. The upper end of the tubular shaft 62 is journaled within the upper drive assembly 34 by bearings 68 and 70 to permit the tubular shaft 62 to spin about the longitudinal axis in a steady fashion. Proximate the lower end of the shaft 66 and attached substantially perpendicular thereto is the granule-distributing plate 72. In a preferred embodiment, the granule-distributing plate 72 is formed from one-quarter inch carbon steel plate and is spaced slightly from the lower end of shaft 66 of the tubular shaft 62. In a preferred embodiment a scraper assembly 74 having at least one, and preferably a plurality of radially distributing arms 76 terminating in vertically disposed blades 78 is mounted to the shaft below the granule-distributing disk 72. Each blade further includes along its distal edge a wiper 80 adapted to engage the interior wall 82 of the coating chamber. Depending upon the application, the wiper 80 may be made from stainless steel, carbon steel, or other material of sufficient strength including some polymeric materials. Just as the granule-distributing disk, the scraper assembly 74 is formed from one-quarter inch carbon steel plate. In the embodiment including the scraper assembly 74, it is contemplated that the granule-distributing plate 72 is rigidly fastened to the scraper assembly 74 such that the two rotate in unison upon rotation of the tubular shaft 62. As seen in FIG. 4, only a portion of the scraper assembly 74 is shown and it is understood in the actual embodiment that two or more distributing arms 76 may be radially extending from the end of the shaft to engage the interior wall 82 of the coating chamber.

The tubular shaft 62 is preferably hollow to define an internal passageway 84. The coating liquid is introduced in the upper end of shaft 64 by way of a nozzle 86 suspended in the upper end of shaft 64. The coupling is a slip coupling in order to permit the rotation of the tubular shaft 62 relative to the nozzle 86. The flow of fluid into the internal passage 84 from the nozzle 86 is controlled in a manner described in greater detail below.

Positioned beneath the lower end of the granule distributing assembly 60 and aligned with the longitudinal axis thereof is a liquid atomizer array assembly 90. The liquid atomizer array assembly 90 is comprised of a plurality of liquid atomizer disks 92 stacked in tandem relative to one another upon frusto-conical spacers 94. Each of the plurality of liquid atomizer disks 92 include a concave upper surface 96, are generally circular in plan form, and have a serrated peripheral edge 98 defining a lineal circumference greater than that of a circle of equal diameter. Each of the plurality of liquid atomizer disks 92 further include concentrically arranged slots 100 of predetermined dimensions to permit the passage of fluid from a upper disk to the disks below. All but the lower most disk in the liquid atomizer array 90 includes the concentrically arranged perforations or slots 100. In a preferred embodiment, each of the liquid atomizer disks is formed from sixteen gauge stainless steel.

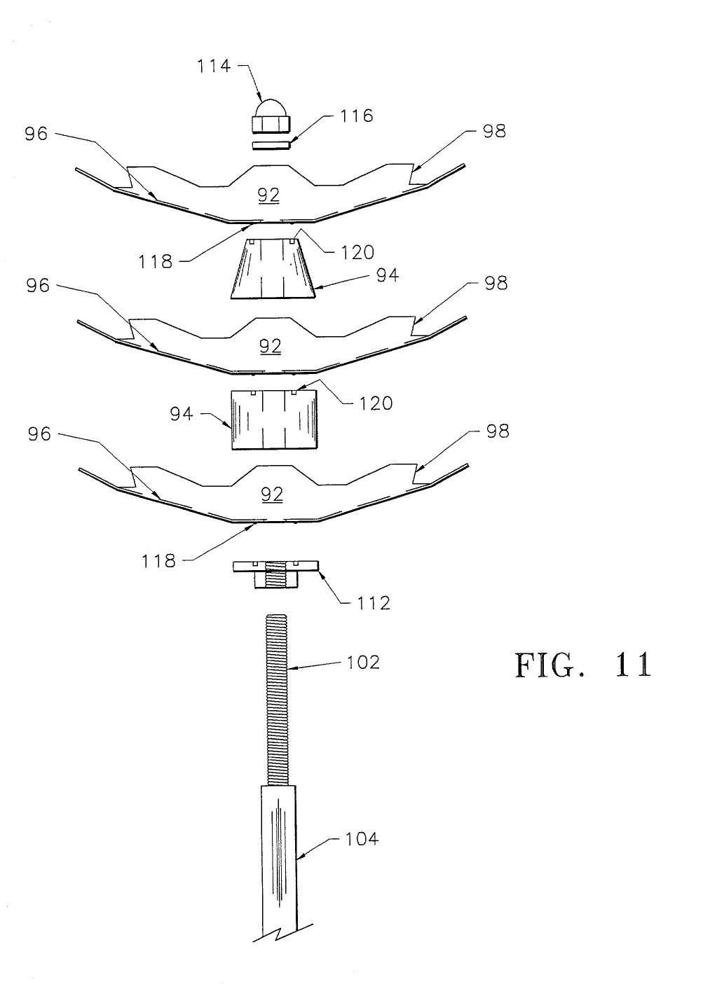

The liquid atomizer array 90 formed by the liquid atomizer disks 92 and the frusto-conical spacers 94 are mounted on the upper end 102 of a shaft 104 journeled by a upper bearing 106 proximate the upper end 102 and by a similar bearing 108 proximate a lower end 110. As best illustrated in FIG. 11, the liquid atomizer disks 92 and frusto-conical spacers 94 are received along a threaded end portion 102 of the shaft 104 by a flanged nut 112, a cap nut 114, and a washer 116. To maintain the relative position of the plurality of liquid atomizer disks 92 with respect to each other, and the frusto-conical spacers 94, and the fasteners 112 and 114, each of the liquid atomizer disks 92 may include protruding lugs or detents which extend from the lower surface of each liquid atomizer disk 92 and are adapted to engage keyed slots 120 formed in the upper surface of the underlying flanged nut 112 or frusto-conical spacer 94. The shaft 104 for the liquid atomizer array 90 is oriented vertically within the coating chamber 30 axially below the tubular shaft 62 of the granule distributing assembly 60 by a shaft support sleeve 122, the upper and lower ends of which are adapted to be attached to the upper and lower bearings 106, 108 respectively by way of flanges. The vertical orientation of the shaft support sleeve 122 is maintained by the frame assembly 24 interconnected to a lower flange of the shaft support sleeve 122 adjacent the discharge transition 32. Additional assistance is provided by the wall 124 of the discharge transition 32 where it is welded with the exterior of the shaft support sleeve 122. This allows the upper end of the shaft support sleeve 122 and liquid atomizer array 90 to be substantially freestanding within the coating chamber 30 and substantially free from any structures which would inhibit the downward flow of the granules from the granule-distributing plate 72 to the bottom of the discharge transition 32. In situations where very high revolutions of the liquid atomizer array 90 are used, such as five thousand rpm or greater, the upper end of the shaft support sleeve 122 is braced with a cross member formed by one-quarter inch steel bar stock for stability.

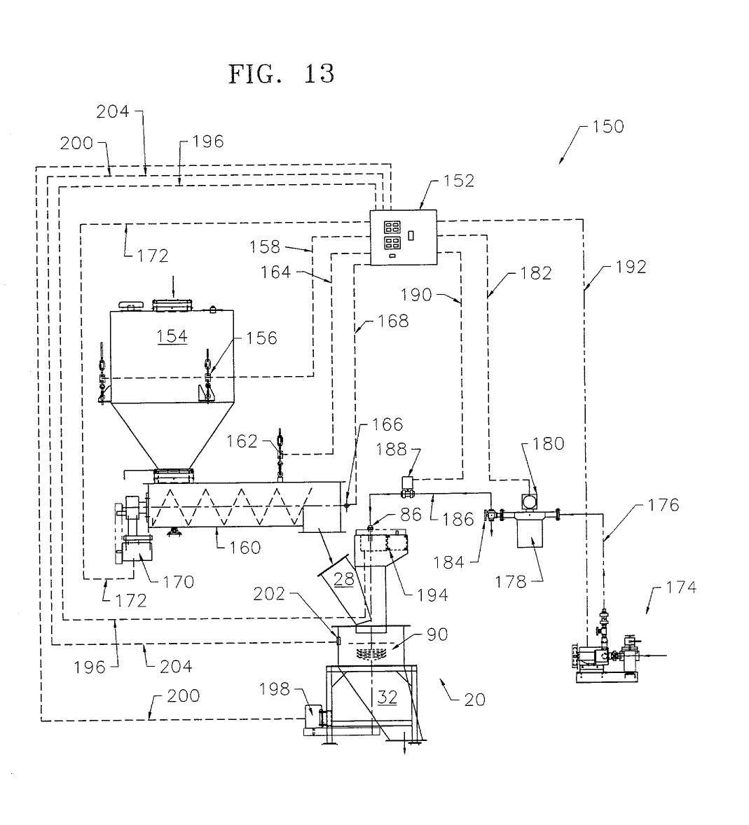

FIG. 13 is a schematic illustration of one embodiment of a coating system 150 utilizing with the coating machine 20. A centrally located computer or microprocessor 152 gathers data from a plurality of sensors which in turn is utilized to control certain operations of the coating system 150. For example, raw material stored in a bin 154 is weighed by scales 156 which provide data over line 158 to the microprocessor 152. A tare weight of the bin 154 is input into the microprocessor 152 such that the starting weight of the bin containing the raw materials can be determined. The scales 156 can then provide data as to the amount of raw materials being dispensed from the bin 154 during the coating process. The bin 154 is attached at its lower end to a weigh screw conveyor 160 which transports raw material from the bin 154 to the inlet hopper 28 of the coating machine 20. The weight of the raw material being transported within the weigh screw conveyor 160 is also measured by a scale 162 which is transmitted to the microprocessor 152 over line 164. The rotational speed or feed rate of the screw conveyor 160 is measured by a sensor 166 which sends data over line 168 to the microprocessor 152. Depending upon the characteristics of the raw material and other data described in greater detail below, the microprocessor 152 can adjust the feed rate of the raw material from the bin 154 to the inlet hopper 28 by controlling the speed of the conveying motor 170 over line 172.

In addition to monitoring the amount of raw granule material provided to the coating machine 20, the coating system 150 also monitors and controls the amount of liquid supplied to the system. A pump 174 may provide a liquid such as a water or other solvent through a line 176 through a regulator 178 whose pressure is monitored by a sensor 180 operably coupled to the microprocessor 152 via line 182. A valve 184 couples the output end of the regulator 178 via a line 186 to the nozzle 86 located in the upper end of the coating machine 20. A solenoid valve or other similarly electronically controlled valve in line 186 controls the amount of fluid provided to nozzle 86; valve 188 being operably coupled to the microprocessor 152 via line 190. The pressure can be regulated or the amount of fluid increased or decreased based on input from the microprocessor 152 over line 192.

In a like fashion, and based upon all the parameters detected by the various sensors within the system, the microprocessor 152 can adjust the spin rate of the granule-distributing plate 72 by adjusting the speed of the motor 194 over line 196. In addition, the rotation rate of the liquid atomizer array 90 can be adjusted via motor 198 via line 200.

Although the above system has been described as providing liquid to the coating machine 20 via the pump 174, it is contemplated that line 186 may be coupled to one or more additional lines to receive additives which are mixed with the primary fluid for application to the granule material. These plumbing systems will not be described in detail as it is contemplated that one of ordinary skill in the art can provide a variety of systems for providing the proper fluid mixture to the granule material. The proportions of these materials may be measured by volume or by weight and controlled with various pumps and/or metering valves to provide the proper mixture prior to providing the fluid to the nozzle 86 at the upper end of the coating machine 20.

In operation, the raw materials are loaded into bin 154 for transport via weigh screw conveyor 160 to the inlet hopper 28 of the coating machine 20. Prior to the receipt of the granule material, the coating machine granule-distributing plate 72 and the scraper assembly 74 are actuated so as to rotate at the desired speed, dependent upon the size of the granular material and the flow rate. Prior to this step, the opening or inlet to the granule-distributing plate 72 has been established by adjusting the flow control collar 40 to the appropriate height. It should be noted at this point, that the position of the flow control collar 40 may be also adjusted remotely depending upon perimeters detected and set by the microprocessor 152. In example, controls for the operation of the flow control collar 40 are not illustrated, but could be easily provide for with screw actuators coupled to the linkage arms 46. Substantially simultaneously with the startup of the granule-distributing plate 72 and the scraper assembly 74, motor 198 is actuated to spin the liquid atomizer array 90 at the desired speed. Just prior to the granule material being fed to the inlet hopper 28, the microprocessor 152, or operator for that matter, starts the flow of fluid from pump 174 through lines 176 and 186 to the nozzle 86 such that it flows down through the internal passage 84 within tubular shaft 62 and is applied to the liquid atomizer array 90. The amount of fluid provided passes through the concentric slots 100 formed in the various atomizer disks 92 such that a zone of atomized fluid is provided within the coating chamber at the desired concentration and thickness. Shortly after the introduction of the coating liquid, the screw conveyor 160 provides the granule material to inlet hopper 28 which in turn is dispensed onto the rotating granule-distributing plate 72. The spinning granule-distributing plate 72 cause the granules to flow off the disk at an even rate due to the centrifugal force, creating a descending cylindrical curtain of granules through the coating chamber 30. As the granules descend through the coating chamber 30, the atomized liquid within the zone contacts the granules. Moreover, air currents generated by the liquid atomizer array 90 actively circulates the atomized liquid to increase the collision between the granules and the liquid to substantially increase the coating efficiency and surface area. After the granules pass through the zone of atomized liquid, they are directed by the discharge transition 32 to a second conveyor system where they are transported to a desired location. It is contemplated that during the transport by the second conveyor system, the granules will be in contact with each other and mix so as to further distribute the coating about the granules. Moreover, excess fluid may be gathered at the bottom of the discharge and in the conveyor such that during the transport the granules are placed in the contact with this excess liquid, thus increasing the opportunity for providing a complete coating around the granules.

The above description is considered that of the preferred embodiments only. Modifications of the invention will occur to those skilled in the art and to those who make or use the invention. In particular, it is anticipated that access doors will be provided in certain ones, if not all, of the various portions of the housing assembly 22 to provide access to certain components for servicing and/or repair. It is further contemplated that one or more of the access doors be mounted with interrupt switches which shut down the entire system should they be opened while the apparatus is operating. Other modifications and/or refinements of the invention may also be made. Therefore, it is understood that the embodiments shown in the drawings and described above are merely for illustrative purposes and not intended to limit the scope of the invention, which is defined by the following claims as interpreted according to the principles of patent law, including the doctrine of equivalents.

We claim:

1. A coating apparatus for granule material, comprising:
a housing;
a rotational granule-distributing disc disposed within said housing proximate an upper end of said housing,
an array of liquid atomizing discs located below said distributing disc and having progressively sized openings defined therein; and
a liquid dispenser intermediate said distributing disc and said array of atomizing discs.

2. The coating apparatus as defined in claim 1, further comprising, a scraper assembly concentric with said distributing disc and engaging an internal wall of said housing.

3. The coating apparatus as defined in claim 1, further comprising:
an inlet disposed at an upper end of said housing; and
an adjustable collar disposed at a lower end of said inlet and above said distributing disc for controlling a flow of granule material onto said distributing disc.

4. The coating apparatus as defined in claim 1, further comprising:
a weigh conveyor attached to said inlet for introducing granule material into the coating apparatus; and
a mixing conveyor attached to a lower end of said housing for transporting and mixing the granule material away from the coating apparatus.

5. The coating apparatus as defined in claim 1, wherein said array of liquid atomizing discs includes:
a plurality of discs, each generally circular in plan form and having a serrated peripheral edge for providing a circumference lineal distance greater than that of a circle of equal diameter; and
all but one of said plurality of discs including said progressively sized openings wherein said openings are arranged concentrically about a center of each disc to permit a liquid to pass from said liquid dispenser onto a lower one of said plurality of discs.

6. The coating apparatus as defined in claim 1, wherein said liquid dispenser includes a nozzle disposed above an uppermost of said liquid atomizing discs and concentric with said rotational granule-distributing disc within said housing.

7. The coating apparatus as defined in claim 1, further comprising:
a first drive system disposed above said housing and operably coupled to said distributing disc; and
a second drive system disposed below said housing and operably coupled to said array of liquid atomizing discs.

8. The coating apparatus as defined in claim 2, wherein said scraper includes at least one arm extending radially from said distributing disc and having a member engaging said internal wall of said housing to remove the granule material therefrom.

9. The coating apparatus as defined in claim 5, wherein said plurality of discs include a plurality of conical spacers axially separating each of said plurality of discs from one another.

10. The coating apparatus as defined in claim 7, wherein said first drive system, includes:
a hollow shaft having said rotational granule-distributing disc attached proximate a lower end, and an upper end extending through and journaled to an upper end of said housing;
a first motor attached to an upper end of said housing; and
a first transmission member interconnecting said first motor to said upper end of said hollow shaft.

11. The coating apparatus as defined in claim 7, wherein said second drive system, includes:
a shaft having an upper end attached to said array of liquid atomizing discs and journaled within said housing, and a lower end extending from said housing and journaled below said housing;
a second motor attached to a lower end of said housing; and
a second transmission member interconnecting said second motor to said lower end of said shaft.

12. The coating apparatus as defined in claim 10, wherein said upper end of said hollow shaft includes a coupling for placing a fluid line in said upper end of said hollow shaft.

13. An apparatus for coating granule material, comprising in combination:
an inlet;
a housing attached to a lower end of said inlet and having a longitudinal axis;
a flow collar disposed at a lower end of said inlet for controlling an influx of the granule material into said housing;
a rotatable granule-distributing disc concentrically disposed along said longitudinal axis of said housing and below said flow collar, for creating a descending cylindrical curtain of granule material within said housing;
a first drive system disposed above said housing and interconnected to said rotatable granule-distributing disc;
a scraper assembly concentric with said rotatable granule-distributing disc and coupled to said first drive system, for rotatably engaging an inner surface of said housing;
a plurality of liquid atomizing discs disposed in tandem along said longitudinal axis of said housing and below said rotatable granule-distributing disc, each of said discs generally circular in plan form and having a serrated peripheral edge defining a lineal circumference greater than that of a circle having a diameter equal to one of said discs;
a second drive system disposed below said housing and interconnected to said plurality of liquid atomizing discs;
a liquid dispenser above said plurality of liquid atomizing discs and coaxial with said rotatable granule-distributing disc; and
a discharge chute attached to a bottom of said housing for dispensing the liquid-coated granule material.

14. A method for covering a granule material with a liquid coating, comprising the steps of:
dispensing the granule material into an inlet hopper;
controlling a flow of the granule material from said inlet hopper onto a rotating granule-dispensing disc disposed within a housing to create a falling cylindrical curtain of granule material within said housing;
spinning below said granule-dispensing disc, and coaxial with said falling cylindrical curtain of granule material, an array of stacked liquid dispensing discs at a speed in excess of one thousand five hundred revolutions per minute;
dispensing a liquid onto said array of stacked liquid dispensing discs through a shaft coaxial with said granule-dispensing disc, and causing said liquid to be atomized and dispersed radially from said spinning array of stacked liquid dispensing discs to create a zone of atomized liquid through which said falling cylindrical curtain of granule material passes;
generating air currents within said zone of atomized liquid to encourage the atomized liquid to contact the granule material and coat the granule material; and
gathering the coated granule material and excess liquid at a bottom of said housing, and further mixing the coated granule material with the liquid during transport to a desire location.

15. The method as defined in claim 15, wherein the step of dispensing said liquid onto said array of stacked liquid dispensing discs to create a zone of liquid further includes dispensing the liquid onto lower ones of said spinning discs within said array of stacked liquid dispensing discs through progressively smaller passages defined in said array of stacked liquid dispensing discs.

16. A liquid dispensing array for a granule material coating machine, comprising:
a plurality of disks stacked in tandem relative to one another from an upper end to a lower end, each of said plurality of disks being concave on an upper surface, generally circular in plan form, and having a serrated peripheral edge defining a lineal circumference greater than that of a circle of equal diameter, each of said plurality of disks in order from said upper end to said lower end having a progressively smaller concentrically arranged passages for permitting the passage of a liquid from an upper disk to a lower disk; and
a plurality of conical spacers, each axially separating one of said plurality of disks from another.

17. The liquid dispensing array as defined in claim 16, further comprising a plurality of lugs extending from a lower surface of each of said plurality of disks and said conical spacers for engaging a corresponding detent in a mating upper surface of each of said plurality of disks and said conical spacers for interlocking said plurality of disks and said conical spacers in fixed alignment.

18. The liquid dispensing array as defined in claim 17, further comprising:
a shaft having a threaded end for receiving said plurality of disks and said plurality of conical spacers thereon in spaced tandem relationship;
a shaft support sleeve supporting said shaft in a preferred orientation; and
a fastener received at an end of said threaded end for retaining said plurality of disks and said plurality of conical spacers thereon in fixed relation.
